(19) United States
(12) Patent Application Publication
(10) Pub. No.: US 2005/0041656 A1
(43) Pub. Date: Feb. 24, 2005

(54) Method for monitoring a communication network and system therefor

(76) Inventors: Nicolas Dubois, Mareil-Marly (FR); Benoit Fondeviole, Paris (FR); Emmanuel Dauvergne, Paris (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(21) Appl. No.: 10/501,389

(22) PCT Filed: Jan. 7, 2003
(86) PCT No.: PCT/FR03/00022

(30) Foreign Application Priority Data
Jan. 15, 2002 (FR) 02/00,426

(51) Int. Cl. H04L 12/56

(52) U.S. Cl. 370/389

(57) ABSTRACT

An operation of a packet communication network is monitored through packets addressed to or transmitted by a control unit of a router pertaining to the communication network. Therefore, a collecting module can be connected to a link of the communication network so as to collect packets corresponding to second packets transferred at an interface between a routing unit and a control unit of a router. The collected packets are selected, then a content and coordinates of the selected packets are sent to a recording unit. In a preferred embodiment, the collecting unit is integrated within the router and the recording unit is connected to the communication network remotely from the router containing the collecting unit.

The present invention concerns the operation of a communication network operating by transmission of packets.

It concerns more particularly a method for monitoring the operation of a packet transmission communication network.

Such a communication network comprises packet transfer elements, called routers, that are interconnected and that constitute relays for the transfer of packets between an originating point and a destination point of this network. Packets are produced by a transfer element of the network or by a user terminal connected to the network intended for another transfer element of the network or for a receiving terminal. Various transmitting and/or receiving communication terminals may be connected to originating or destination points of the network. Another network, for example a local area network or LAN, may also be connected to these points by appropriate routers, called gateways. In general, the links between the routers form a meshing of the geographic zone served by the communication network. Thus, for the transfer of a packet between an originating point and a destination point of the network, several paths are possible, each corresponding to a succession of routers and links via which the communication packets are transferred.

Various methods are used for monitoring the operation of such communication networks when these networks are implemented, or during operations of inspection or of maintenance of these networks. Such methods are for example based on the Simple Network Management Protocol (SNMP), see RFC 1157 published in May 1990 by the IETF (Internet Engineering Task Force) organization. In particular they have the drawback of proceeding by polling the routers to obtain the operating elements of those routers. A portion of the activity of the routers polled is then dedicated to responding to these polling operations, which reduces their availability for the task of transferring packets and may disrupt the processing of the packets. In extreme cases, this polling may even cause congestion of the network, culminating in the stoppage of its operation, due to a residual availability of the routers insufficient to ensure the transfer of the packets.

Another disadvantage of these methods based on the SNMP protocol is their vulnerability relative to actions directed against the operation of the network or against its users. Such actions are carried out by malicious individuals who may use the same channels as the polling operations addressed to the routers for purposes of inspecting the operation of the network.

Other methods for inspecting the operation of the routers are focused on parts of their internal operation which depend on how they are produced and constituted. They then have the drawback of requiring a knowledge of the routers that is held by the manufacturer of each hardware item. This knowledge is not always easily available for the operator of a communication network that incorporates these devices. Indeed, the recommendations of the general standards do not cover the internal operating mechanisms of the routers and the latter are specific to each manufacturer.

An object of the present invention is to propose a method for monitoring the operation of a communication network that can be easily implemented by the operator of a communication network.

The invention proposes a method for monitoring the operation of a packet transmission communication network comprising interconnected routers each including a routing unit and a control unit supervising the routing unit. The routing unit is arranged for transferring first packets between external ports of said router and for transferring second packets between the external ports of the router and an internal port connected to the control unit. The method comprises the following steps, parallel to the transfer of first and second packets by the routing unit:
selecting packets corresponding to at least some of the second packets transferred at said internal port of the router by means of a determined collection filter; and
recording a content of the selected packets on a recording medium.

One advantage of the method of the invention lies in the fact that the communication network operating data collected relate to an interface between the routing unit and the control unit of a router. These data originate from packets transported by the communication network and their format and content are defined by widely used standards. Thus, a general knowledge of the operation of the networks is sufficient for the interpretation of the collected data.

Another advantage of the collection of data from an interface between the routing unit and the control unit of a router results from the fact that these data define the operation of the network. A distinction is thus directly possible between a malfunction which occurs in the execution of the routing of the packets by the network and a control error of the network. In particular, these data contain elements which relate to several protocols, including routing protocols used for the routing of the packets by the communication network.

Another advantage of the collection of data from an interface between the routing unit and the control unit of a router lies in the fact that the collected packets comprise prefixes linked to the various protocols and/or to the actions commanded by these packets. These prefixes are therefore immediately accessed to by reading in the collected packets, without any particular operation of prefixe association or restoration.

An additional advantage of the method of the invention lies in the fact that these operating data are collected and then recorded without active intervention of the router to which these data relate. Thus, no resource of this router is used to collect the data, so the router may in parallel, without disruption, continue the transmission of the packets.

According to the invention, a content of collected packets associated with an interface between the routing unit and the control unit of a router is recorded. In particular, the packets can be recorded in the state in which they are collected. This recording may be exhaustive in respect to all the packets exchanged between the routing unit and the control unit of the router, or may concern a selection of the packets exchanged between these two units. This selection may be carried out by a filter, called a collection filter, relating to various characteristics of the packets. Exhaustive recording corresponds to a collection filter of the all-pass type.

The recording of the content of a packet associated with the interface between the routing unit and the control unit of the router may be accompanied by a recording of coordinates associated with that packet. Such coordinates attached to the packets may in particular be a destination address or source address, corresponding respectively to a network element sending or receiving a packet, a time of collection of this packet, a given prefix, the type of message transported by these packets, etc. For example, a recording in chronological order of the collected packets from the interface between the routing unit and the control unit may be obtained according to the method of the invention, as a function of the respective times of collection of the packets, between programmed collection start time and end time. The collection filter then applies selection criteria relating to specified coordinates.

The recording of the packets thus collected may then be used in different ways, depending on the objective in which this recording was carried out, or in the context of particular applications.

One objective in which such a recording may be carried out is the monitoring of the operation of a communication network. This monitoring, which may be performed substantially in real time relative to the operation of the network, may be aimed at searching for particular malfunctions, identifying modifications occurring on network operation parameter values, verifying the structure of the network relative to general rules of design or searching for malicious intrusions into the operation of the network.

Such a recording may also be used later relative to the moment of recording. The recording is then used for archiving data characterizing the network operating conditions. It may be read at a time subsequent to the time of recording, for example following operating anomalies of the communication network detected by the operator or reported to the operator by users of the network.

An application of the recording of a content and of coordinates of packets associated with an interface between the routing unit and the control unit of a router is the simulation of the operation of a communication network. Accordingly, such packets, selected in appropriate manner at the time of their collection, are used to characterize a part of the operation of the network and subsequently to simulate that operation on a platform designed for that purpose, based on the recording of these packets.

Such a simulation of the operation of a network is of interest in the following circumstances and applications:
when an operating anomaly is suspected. The “playback” of the network operation is then an essential aid for identifying the origin of the anomaly;
evaluation of network operation by making changes in the definition of or in the values of the network operation parameters. This may involve for example adjusting certain network topology parameters in order to find a more efficient operation of the network than that which corresponds to the recorded data;
evaluation of operation by introducing new functionalities added to the functions already performed by the network. One object may be in particular to determine the influence of the added functionalities on the availability or congestion of the network;
evaluation of a network operation by introducing new elements, in particular new transmission elements, in certain locations in the network. Such a simulation may be designed for evaluating the influence of the newly introduced element on the behavior of the network, and for testing this new element itself relative to the environment that makes up the network during the period corresponding to the recording. Such simulations are particularly useful in studying possibilities of extending a network relative to the risks of congesting the transfer capabilities of certain portions of that network.

Another application of the recording of contents and coordinates of the packets associated with an interface between the routing unit and the control unit of a router is the centralization of a part of the determination of the paths intended to be assigned respectively to packets. Accordingly, it may be advantageous, in order to economize on resources in the routers, to carry out, in a specific unit dedicated to that task, a portion of the construction or of the updating of a table for determining the paths assigned to the packets. For executing this task, this specific unit may use data characterizing the operation of the network, in particular network topology data, originating from the content and the recorded coordinates of the packets collected according to the method of the invention.

The invention also concerns a system suitable for implementing the abovementioned monitoring method, applied to a router of the network including a routing unit and a control unit supervising the routing unit, the routing unit being arranged for transferring first packets between external ports of said router and for transferring second packets between the external ports of the router and an internal port connected to the control unit. According to the invention, the monitoring system comprises:
means for selecting packets corresponding to at least some of the second packets transferred at said internal port of the router by means of a determined collection filter; and
a unit for recording a content of the selected packets on a recording medium.

The invention also concerns a router for a packet transmission communication network, comprising a routing unit and a control unit supervising the routing unit, the routing unit being arranged for transferring first packets between external ports of the router and for transferring second packets between the external ports of the router and an internal port connected to the control unit. According to the invention, this router also comprises a collection module connected to an interface between the routing unit and the control unit to select at least some of the second packets and extract a content to be recorded of the second packets selected in parallel with the transfer of first and second packets by the routing unit.

Other features and advantages of the present invention will appear from the following description of two nonlimiting exemplary embodiments, with reference to the appended drawings, in which:

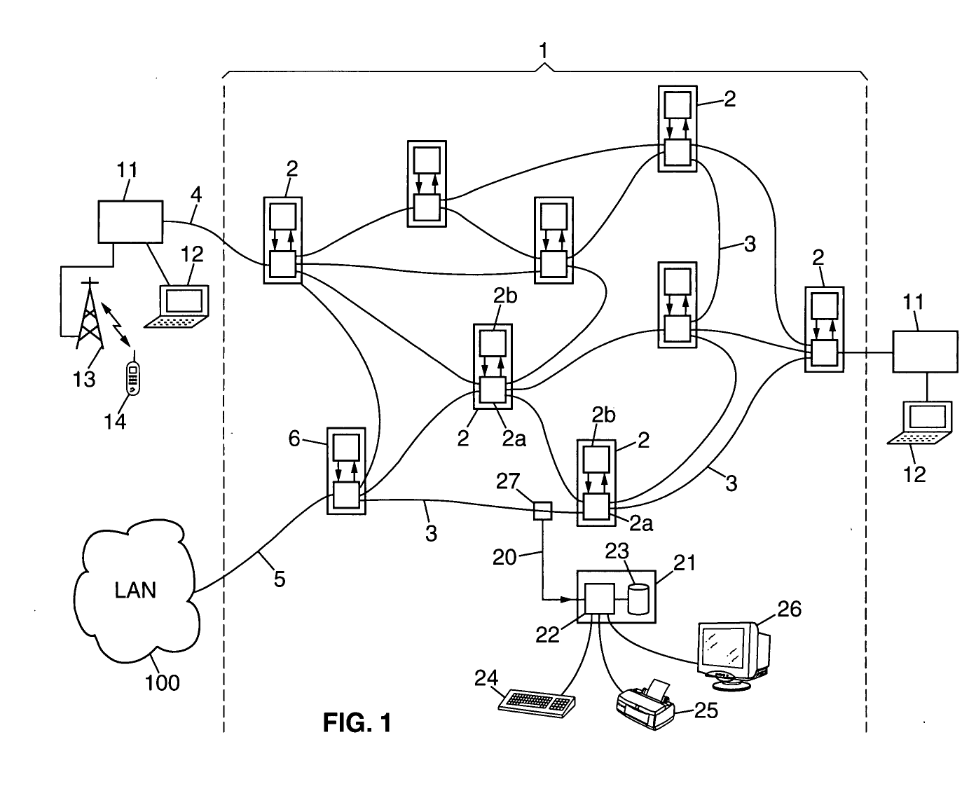

FIG. 1 represents a communication network fitted with a system of collection and recording according to a first embodiment of the invention;

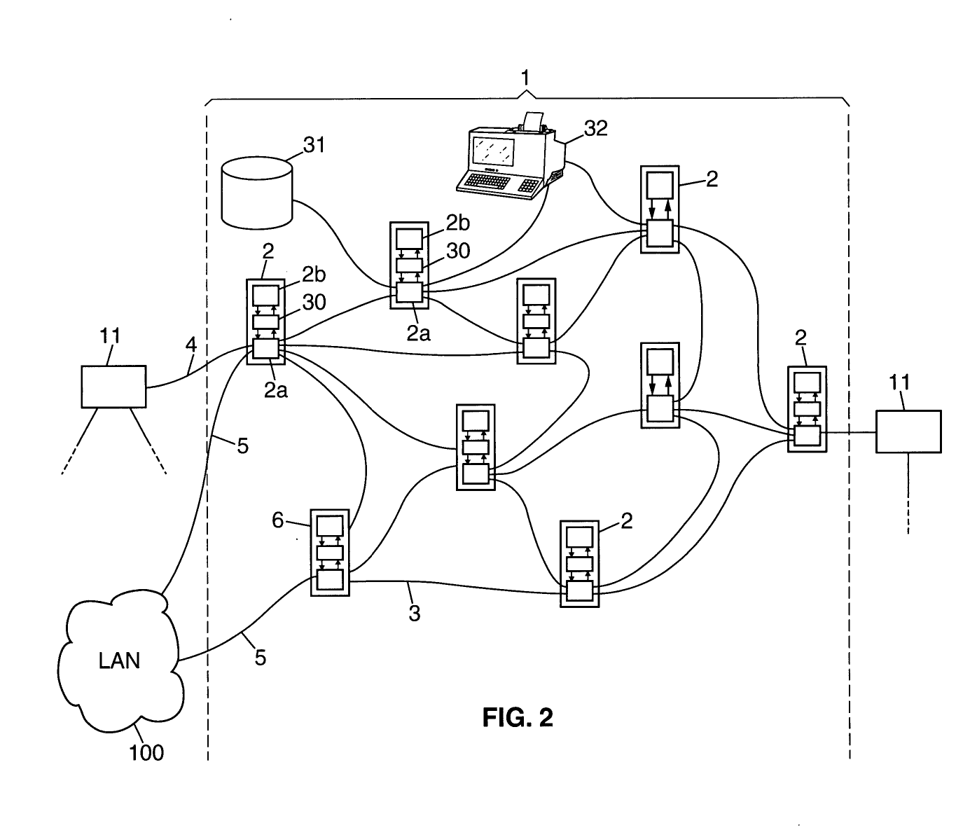

FIG. 2 represents a second embodiment of a system of collection and recording incorporated into a communication network.

According to FIG. 1, a packet transmission communication network 1 is made of routers 2 interconnected by links 3, also called arcs. A given router 2 is connected to another router of this network 1, but preferably to several other routers 2, in order to allow several paths between an originating point and a destination point for packets transmitted via this communication network 1 between these originating and destination points.

A router 2 of this network may also be connected via a peripheral link 4 to a host unit 11 to which are connected communication terminals of various types, for example a server 12 or a radio communication unit 13 used for links with mobile terminals 14. Such a communication network 1 may then transmit data, in packet form, between users equipped with terminals 12, 14 respectively.

Furthermore, certain routers 6 may connect external communication networks to the communication network 1, for example a local area network (LAN) 100. These routers 6 then fulfill a gateway function between the main communication network 1 and the local area network 100.

The internal architecture of each router 2 is usually seperated into two units. A first unit, represented schematically in FIG. 1 by a lower level 2a inside each router 2, is called a routing unit. In particular it carries out the transmission of packets by setting up a switch, for each packet, between the inputs and the outputs that belong to an interface between this router 2 and the rest of the communication network 1, or between this router and another transmission element outside the communication network 1.

A second unit 2b, called the control unit and represented schematically in FIG. 1 by a higher level inside each router 2, controls the routing unit 2a for commanding the switchings according, in particular, to the destination addresses of the packets. A physical or software interface separates this routing unit 2a from this control unit 2b within each router 2.

For a given packet, according to its destination address, the control unit 2b determines, based on a routing table, the path to be assigned to the packet for its routing by the communication network according to the metrics values of the links concerned, the congestion levels of these links, and other parameters. The OSPF v2 (Open Shortest Path First, see RFC 2328 published in April 1998 by the IETF) procedure is an example of such a path determination method currently used.

To assign a transmission path to each packet, the control unit 2b has information concerning the architecture of the communication network 1, and information concerning the links 4, 5 of that network with other networks 100, host units 11 or various installations connected to routers of the communication network 1.

This information is transmitted by packets intended for the control unit 2b of a router 2, received at the routing unit 2a of that router. The routing unit 2a then transfers these packets to the control unit 2b. Reciprocally, the control unit 2b of a router 2 may send packets to other routers 2, or other elements of the communication network 1, via the routing unit 2a of the router 2.

Some of these packets sent or received by the control unit 2b of a router 2 participate in the generation of information concerning the architecture and operation of the communication network 1. Like all the packets routed via the communication network 1, they are made up of successive layers each dependent on different protocols.

The information concerning the architecture of the communication network 1 includes in particular information called network topology information. This includes references, in terms of addresses, of the other routers 2 of the network, or of at least some of them, and metrics values assigned respectively to each elementary link between two routers.

The topology information is regularly updated by automatic detection mechanisms such as, for example, those of the IGP protocol (Interior Gateway Protocol) These mechanisms detect temporary or durable modifications which may occur in the network, and are used for the broadcasting between the routers 2 of information elements concerning detected modifications. Such modifications are, for example, communication link disconnections, the change of metrics values of one or more links, the connection of additional transmission elements, a shutdown of a router or a suspension of certain transmission elements. Correlations between some of this information, for example between information concerning the operation or non-operation of links 3, are used to generate more global information. They are used in particular for determining a portion of the communication network 1 that is momentarily isolated, or non-adjacent, relative to the rest of the network, due to a lack of available paths for packets between a source outside this isolated portion and a terminal belonging to this isolated portion.

Other information concerns, for example, the connections 4, 5 of the communication network 1 to external elements 11, 100. Such information may in particular be obtained according to the EGP protocol (“Exterior Gateway Protocol”, see RFC 904 published in April 1984 by the IETF).

All this information is acquired by the sending of packets originating from the control unit 2b of a router 2 to other transmission elements of the communication network 1, and by receiving packets via this control unit 2b sent by other transmission elements of the network. Thus, the packets exchanged at the interface between the routing unit 2a and the control unit 2b of a router 2 on the one hand reflect the operation of the network, and on the other hand define a context of the packet transmission activity of this router. A collection of these packets therefore is used for entering operating data of the router and global operating data of the communication network.

According to a first embodiment of the method of the invention, this collection is carried out by a collection module 27 connected to a data processing unit 21. This data processing unit 21 may consist of a normal computer. A link 20 connects this data processing unit 21 to the collection module 27. The collection module 27 is connected for example to a link 3 terminating at a determined router 2. The collection module 27 is arranged for collecting those of the packets transported via the link 3 that are sent by or intended for the control unit 2b of this determined router 2. Usually, the collection module 21 transmits transparently, that is without intervention on the packets or on their transport, all the packets carried by the link 3 to which it is connected.

The data processing unit 21 comprises an interface 22 to which is connected the link 20, programmable via an input device 24 such as a keyboard. It also comprises a recording unit 23, consisting of a recording medium, for example with a capacity of several hundred gigabytes, and means for reading/writing data on this recording medium. Furthermore it is connected to peripheral devices allowing an operator to read data, such as a printer 25 and a visual display unit 26.

The programming of the interface 22 may consist in the generation of a collection filter of the packets collected by the collection module 27, which correspond to packets transmitted between the routing unit 2a and the control unit 2b of the determined router 2. This filter may relate to varied criteria such as, for example, the content of certain header fields of the packets indicative of a protocol to which the content of the message conveyed by this packet relates, the transmission time of this packet or any other selection criterion. These packets, possibly accompanied by coordinates attached to these packets, such as the collection time of each packet, are then sent to the recording unit 23 to be written onto the recording medium.

The same set of components 21-26 may also be used for reading the data thus recorded, including the recorded content of packets and of the coordinates attached to those packets. A read filter, also programmed at the interface 22 in view of a specific usage of these data, may then be used to selecting the packets whose content and coordinates are read among all the recorded data.

This first embodiment of the invention has the advantage of requiring very little hardware, limited for example to an appropriate laptop computer and to a collection module. This collection module, connected to the laptop computer, is connected for the duration of recording to a link 3 of the communication network 1 by an operator. This link 3 must be chosen according to its position in the communication network 1 in order to obtain pertinent data relative to the information sought concerning the operation of the communication network 1, or relative to the application for which these data are collected.

This first embodiment requires an operator to move to a chosen point on the link 3 in order to connect the collection module 27.

The collected data are limited to the packets transported by the link 3 to which the collection module 27 is connected.

A preferred embodiment of the invention, corresponding to FIG. 2, does not have these limitations and also can be used to make correlations between the data gathered simultaneously at several routers 2.

FIG. 2 reiterates the communication network elements of FIG. 1. The elements of this network that are identical to those presented in detail above are not repeated here, nor is the description of the operating principle of such a network. References that are the same in FIGS. 1 and 2 reflect similar elements.

In this preferred embodiment, each router 2, or at least some of the routers 2 of the communication network 1, comprises, in addition to the routing unit 2a and the control unit 2b, a collection module 30 connected at the interface between these two units. This collection module 30 is set up for making possible the collection of second packets without disrupting their transmission within the router 2, nor their role in the operation of the communication network 1. It is installed permanently in the router 2.

Furthermore, this collection module 30 is arranged for being also capable of sending packets intended to be transmitted by the communication network 1, via the routing unit 2a.

A recording unit 31, comprising a recording medium and means for reading/writing on that medium, and a supervision unit 32 are furthermore connected to the communication network 1. This supervision unit 32 and this recording unit 31 may, where appropriate, be combined within one and the same device, but not necessarily. The supervision unit 32 comprises usual input and display interfaces. In this configuration, a collection module 30 currently used, the recording unit 31 and the supervision unit 32 are geographically remote from one another, being connected via the communication network 1.

In this preferred embodiment of the invention, the selected and recorded packets are therefore directly second packets transferred at said internal port of a router 2.

The collection module 30 located in a router 2 can be programmed by means of programming codes sent by an operator from the supervision unit 32. These programming codes, which contain for example data for activating the collection of packets, are transported by the communication network 1 in the form of packets addressed to said collection module 30. These programming codes may also contain the data necessary for a selective collection of packets, according to particular selection criteria constituting a collection filter.

In response to this collection instruction, the collection module 30 returns, via the communication network 1 to the recording unit 31, a content of the collected packets and coordinates attached to those packets. In this purpose, the content and the coordinates of the packets concerned are configured in the form of packets for transmission via the communication network 1 in the same manner as packets sent by a user terminal of the communication network 1. On receipt of these packets, the recording unit 31 then proceeds to record the data collected by the collection module 30 and contained in those packets.

In this embodiment, the supervision unit 32 can send collection instructions simultaneously to different collection modules 30 located in several routers 2. Each of them then returns to the recording unit 31 the data collected at the router 2 in which it is placed. The coordinates attached to the content of the collected packets then comprise an address of the router 2 in which each packet has been collected.

Such a simultaneous acquisition of operating data at several points of the communication network 1 allows a better characterization of the operation of the latter. In particular it can be used for making correlations between events occurring at separate points on the communication network 1.

The programming codes sent by the supervision unit 32 to the collection modules 30 and the contents and coordinates of the packets returned by the collection modules 30 to the recording unit 31 may be transported in encrypted form by the communication network 1. This precaution can be used to avoid use of these data by a malicious individual. For this, encryption elements known to those skilled in the art, or SSL (“Security Shell Layer”), are used in the capture modules 30, in the recording unit 31 and in the supervision unit 32 to encrypt or decrypt the transmitted data.

The recording of the operation data of the communication network 1 corresponding to the collected packets may then be used in different manners.

First of all, it can be used for real-time monitoring of the operation of the network or of certain aspects of this operation according to a packet selection made at the time of reading the recording. For this purpose a read filter is used which comprises criteria for selection of the displayed packets. Some criteria of the read filter are, for example, a date of appearance of the packet, the type of event to which a packet relates, the command protocol to which a content of the packets relates, etc. Various polling methods may then be used to compose requests appropriate to the search made. A monitoring of the network may thus be carried out, relating to very varied aspects of its operation, such as the availability or the level of congestion of certain links, changes of address made by users, changes of metrics values attached to links, a loss of communication with certain portions of network, etc. The presentation of the result of the formulated requests is then adapted to display a particular aspect of the operation of the communication network. Presentations that are much used are, for example, statistical reports repeated over determined periods or histograms relating to selected protocol events.

In like manner, an operation of a communication network recorded over a determined period may be monitored at a time subsequent to the time it occurred, thanks to the recording made according to the invention.

The recorded data corresponding to contents and coordinates of packets transmitted between the routing unit 2a and the control unit 2b of a router 2 may also be used by a unit for simulating the operation of the communication network 1. Specifically, these data include information characteristic of at least a part of the operation of the communication network 1 in progress at the time of the recording. This simulation unit may then reconstitute the operation of the network as perceived at the router or routers 2 in which the packets were collected.

This simulation unit can also be used to simulate the operation of the network by incorporating changes to the definition of the network. Such changes are for example network extensions or the addition of supplementary links, in order to evaluate, before they are implemented, the value and the consequences of these changes on the operation of the communication network 1.

Finally, the recorded data corresponding to contents and coordinates of packets transmitted between the routing unit 2a and the control unit 2b of a router 2 may be used by a device for determining and/or updating routing tables. The routing tables are data sets, usually established and stored within each router 2, which make it possible for the control unit 2b of each router to determine a path to assign to each packet transferred by the communication network 1, according to the address data of that packet. For this purpose, the routing table of a router 2 is updated according to information on evolution and operation of the network, particularly network topology information, which reaches the control unit 2b of the router. This information is also relayed by the router toward neighboring routers in order to allow updates of the tables of all the routers to which this information relates. This therefore provides a local updating of the routing tables, broadcast between the routers by the sending of packets to the control units 2b of each of them.

The recording, according to the invention, of the packets containing the information on the evolution of the communication network 1 can be used for gathering all the operations for determination and updating of the routing tables. For this purpose, a specific unit, in a centralized manner, uses the recorded information and determines the routing table modifications induced by the evolutions of the network. These modifications are then addressed to the different routers 2 concerned for the updating of the routing tables recorded at each of them. These data are addressed, in the form of packets transmitted by the communication network 1, to the control units 2b of each of these routers. Thus, a part or all of the updating of the routing tables is accomplished in centralized manner for several routers, thus providing a global saving of operations performed.

1. A method for monitoring the operation of data collection on the operation of a packet transmission communication network comprising interconnected routers each including a routing unit and a control unit supervising the routing unit, the routing unit being arranged for transferring first packets between external ports of said router and for transferring second packets between the external ports of the router and an internal port connected to the control unit, the method comprising the following steps, parallel to the transfer of first and second packets by the routing unit:
selecting packets corresponding to at least some of the second packets transferred at said internal port of a router by means of a determined collection filter; and
recording a content of the selected packets on a recording medium, said content comprising data on the operation of the network, wherein the selection of packets and an extraction of said content to be recorded of the selected packets are carried out by means of a collection module disposed inside said router and connected to said internal port of said router.

2. The method as claimed in claim 1, wherein a recording unit is connected to the communication network, remote from said router, and said content of the selected packets is sent to said recording unit.

3. The method as claimed in claim 2, also comprising a formatting of said content of the selected packets prior to the sending of this content to the recording unit via the communication network, the formatting comprising the assignment to the content of address data corresponding to the recording unit.

4. The method as claimed in claim 3, wherein the content of the selected packets is encrypted prior to the sending of this content to the recording unit via the communication network.

5. The method as claimed in claim 1, wherein the collection module is remotely programmable by means of program codes sent to the collection module via the communication network.

6. (Cancelled)

7. (Cancelled)

8. (Cancelled)

9. The method as claimed in claim 1, also comprising a step of reading recorded contents of selected packets.

10. The method as claimed in claim 5, also comprising a selection step according to a filter for reading recorded contents of packets selected according to the collection filter.

11. The method as claimed claim 1 wherein said content of a selected packet is recorded with coordinates of said selected packet.

12. The method as claimed in claim 11, wherein the recorded coordinates of a selected packet comprise a timestamp of the collection of said selected packet.

13. The method as claimed in claim 11, wherein the recorded coordinates of a selected packet comprise an address of the router which contains said internal port at which said second packet corresponding to said selected packet is transferred.

14. A system for monitoring of data collection on the operation of a packet transmission communication network comprising interconnected routers each including a routing unit and a control unit supervising the routing unit, the routing unit being arranged for transferring first packets between external ports of said router and for transferring second packets between the external ports of the router and an internal port connected to the control unit, the system comprising:
a means for selecting packets corresponding to at least some of the second packets transferred at said internal port of a router means of a determined collection filter and for extracting the content to be recorded; and
a unit for recording a content of the selected packets on a recording medium,
wherein said router incorporates a collection module connected to said internal port and comprising the means of selection.

15. The system as claimed in claim 14, wherein the recording unit is connected to the communication network remotely from said router.

16. The system as claimed in claim 15, also comprising means of formatting said content of the selected packets.

17. The system as claimed in claim 15, wherein the formatting means comprise means of assigning to the content address data corresponding to the recording unit.

18. The system as claimed in claim 15 also comprising an encryption module for encrypting said content of the selected packets.

19. (Cancelled)

20. The system as claimed in claim 14, wherein the collection module is arranged for receiving programming codes of the collection module via the communication network.

21. (Cancelled)

22. The system as claimed in claim 14, also comprising means for reading on the recording medium the recorded content of selected packets.

23. The system as claimed in claim 22, also comprising means for selecting recorded contents of packets according to a read filter, when the contents of packets selected according to the collection filter are read on the recording medium.

24. The system as claimed in claim 14, wherein the recording unit is arranged for recording said content of a selected packet with coordinates of said selected packet.

25. The system as claimed in claim 24, wherein the recorded coordinates of a selected packet comprise a timestamp of the collection of said selected packet.

26. The system as claimed in claim 24, wherein the recorded coordinates of a selected packet comprise an address of the router which contains said internal port at which said second packet corresponding to said selected packet is transferred.

27. The system as claimed in claim 14, also comprising a unit for simulating the operation of the communication network by using the recorded contents of selected packets.

28. The system as claimed in claim 14 also comprising a unit for constructing and/or updating, based on the recorded contents of selected packets, a table for determining paths intended to be respectively assigned to packets transferred by the routing unit of the router.

29. A router for a packet transmission communication network, comprising a routing unit and a control unit supervising the routing unit, the routing unit being arranged for transferring first packets between external ports of the router and for transferring second packets between the external ports of the router and an internal port connected to the control unit, characterized in that it wherein said router also comprises a collection module connected to an interface between the routing unit and the control unit for selecting at least some of the second packets and extracting a content to be recorded of the second packets selected in parallel with the transfer of first and second packets by the routing unit.

30. A method for characterizing a part of an operation of a packet transmission communication network comprising interconnected routers each including a routing unit and a control unit supervising the routing unit, the routing unit being arranged for transferring first packets between external ports of said router and for transferring second packets between the external ports of the router and an internal port connected to the control unit, said method using data on the operation of said network collected by carrying out the following steps, parallel to the transfer of first and second packets by the routing unit:
selecting packets corresponding to at least some of the second packets transferred at said internal port of a router by means of a determined collection filter; and
recording a content of the selected packets on a recording medium, said content comprising said data on the operation of the network,
wherein the selection of packets and an extraction of said content to be recorded of the selected packets are carried out by means of a collection module disposed inside said router and connected to said internal port of said router.

31. The method as claimed in claim 30, wherein the collected data are also used to simulate said port of operation of the network.
